(19) United States
(12) Patent Application Publication
(10) Pub. No.: US 2024/0192390 A1
(43) Pub. Date: Jun. 13, 2024

(54) SYSTEM AND METHOD FOR ENHANCED FULL WAVEFORM INVERSION

(71) Applicant: Chevron U.S.A. Inc., San Ramon, CA (US)

(72) Inventors: Guojian Shan, Sugar Land, TX (US); Jingru Chen, Katy, TX (US); Leonard Lin Zhang, Sugar Land, TX (US)

(21) Appl. No.: 18/062,989

(22) Filed: Dec. 7, 2022

(51) Int. Cl. G01V 1/30; G01V 1/28

(52) U.S. Cl. CPC G01V 1/303; G01V 1/282

(57) ABSTRACT

A method is described for determining subsurface earth properties using a full waveform inversion that solves the problem of cycle skipping. The method uses cross-correlation, time shifting, and decorrelation as part of the full waveform inversion to find the data residual that is inverted to calculate the model residual. The method is executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for generating an earth property volume for a subsurface of interest using full waveform inversion that does not suffer from cycle skipping.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation, speed, and other properties, referred to herein as earth properties. The seismic waves may reflect from interfaces between the geological media and/or may turn more gradually (e.g., diving waves or refracted waves).

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for accurate models of the subsurface that will improve seismic images and aid in the interpretation of locations of rock and fluid property changes.

### SUMMARY

In accordance with some embodiments, a method for determining subsurface earth properties, including receiving an earth model and a seismic dataset representative of a subsurface volume of interest; generating modeled seismic data from the earth model; cross-correlating the modeled seismic data and the seismic dataset to generate a cross-correlated dataset; shifting the cross-correlated dataset to generate a shifted cross-correlated dataset; performing a decorrelation on the cross-correlated dataset to generate a first dataset; performing a decorrelation on the shifted cross-correlated dataset to generate a second dataset; calculating a data residual between the first dataset and the second dataset; inverting the data residual to determine a model residual; updating the earth model using the model residual to generate an updated earth model; generating a graphical representation of the updated earth model; and displaying the graphical representation on a graphical display is disclosed. The method may perform multiple iterations prior to displaying the updated earth model.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a flowchart of a prior art method for generating a seismic velocity model;

FIG. 2 illustrates problems that arise during the use of a prior art method for generating a seismic velocity model

FIG. 3 illustrates an example system for generating a seismic velocity model;

FIG. 4 illustrates an example method for generating a seismic velocity model;

FIG. 5 demonstrates a step of an embodiment of a method for generating a seismic velocity model;

FIG. 6 demonstrates a step of an embodiment of a method for generating a seismic velocity model;

FIG. 7 demonstrates a step of an embodiment of a method for generating a seismic velocity model;

FIG. 8 demonstrates a result of an embodiment of a method for generating a seismic velocity model; and

FIG. 9 demonstrates a result of an embodiment of a method for generating a seismic velocity model.

Like reference numerals refer to corresponding parts throughout the drawings.

### DETAILED DESCRIPTION OF EMBODIMENTS

Described below are methods, systems, and computer readable storage media that provide a manner of generating seismic velocity models. These embodiments are designed to be of particular use for areas prone to cycle skipping during full waveform inversion.

Advantageously, those of ordinary skill in the art will appreciate, for example, that the embodiments provided herein may be utilized to generate a more accurate digital seismic image (i.e., the corrected digital seismic image). The more accurate digital seismic image may improve hydrocarbon exploration and improve hydrocarbon production. The more accurate digital seismic image may provide details of the subsurface that were illustrated poorly or not at all in traditional seismic images. Moreover, the more accurate digital seismic image may better delineate where different features begin, end, or any combination thereof. As one example, the more accurate digital seismic image may illustrate faults and/or salt flanks more accurately. As another example, assume that the more accurate digital seismic image indicates the presence of a hydrocarbon deposit. The more accurate digital seismic image may delineate more accurately the bounds of the hydrocarbon deposit so that the hydrocarbon deposit may be produced.

Those of ordinary skill in the art will appreciate, for example, that the more accurate digital seismic image may be utilized in hydrocarbon exploration and hydrocarbon production for decision making. For example, the more accurate digital seismic image may be utilized to pick a location for a wellbore. Those of ordinary skill in the art will appreciate that decisions about (a) where to drill one or more wellbores to produce the hydrocarbon deposit, (b) how many wellbores to drill to produce the hydrocarbon deposit, etc. may be made based on the more accurate digital seismic image. The more accurate digital seismic image may even be utilized to select the trajectory of each wellbore to be drilled. Moreover, if the delineation indicates a large hydrocarbon deposit, then a higher number of wellbore locations may be selected and that higher number of wellbores may be drilled, as compared to delineation indicating a smaller hydrocarbon deposit.

Those of ordinary skill in the art will appreciate, for example, that the more accurate digital seismic image may be utilized in hydrocarbon exploration and hydrocarbon production for control. For example, the more accurate digital seismic image may be utilized to steer a tool (e.g., drilling tool) to drill a wellbore. A drilling tool may be steered to drill one or more wellbores to produce the hydrocarbon deposit. Steering the tool may include drilling around or avoiding certain subsurface features (e.g., faults, salt diapirs, shale diapirs, shale ridges, pockmarks, buried channels, gas chimneys, shallow gas pockets, and slumps), drilling through certain subsurface features (e.g., hydrocarbon deposit), or any combination thereof depending on the desired outcome. As another example, the more accurate digital seismic image may be utilized for controlling flow of fluids injected into or received from the subsurface, the wellbore, or any combination thereof. As another example, the more accurate digital seismic image may be utilized for controlling flow of fluids injected into or received from at least one hydrocarbon producing zone of the subsurface. Chokes or well control devices, positioned on the surface or downhole, may be used to control the flow of fluid into and out. For example, certain subsurface features in the more accurate digital seismic image may prompt activation, deactivation, modification, or any combination thereof of the chokes or well control devices so as control the flow of fluid. Thus, the more accurate digital seismic image may be utilized to control injection rates, production rates, or any combination thereof.

Those of ordinary skill in the art will appreciate, for example, that the more accurate digital seismic image may be utilized to select completions, components, fluids, etc. for a wellbore. A variety of casing, tubing, packers, heaters, sand screens, gravel packs, items for fines migration, etc. may be selected for each wellbore to be drilled based on the more accurate digital seismic image. Furthermore, one or more recovery techniques to produce the hydrocarbon deposit may be selected based on the more accurate digital seismic image.

In short, those of ordinary skill in the art will appreciate that there are many decisions (e.g., in the context of (a) steering decisions, (b) landing decisions, (c) completion decisions, (d) engineering control systems and reservoir monitoring in the following but not limited to: Tow Streamer, Ocean Bottom Sensor, VSP, DASVSP, and imaging with both primaries and free surface multiple, etc.) to make in the hydrocarbon industry and making proper decisions based on more accurate digital seismic images should improve the likelihood of safe and reliable operations. For simplicity, the many possibilities, including wellbore location, component selection for the wellbore, recovery technique selection, controlling flow of fluid, etc., may be collectively referred to as managing a subsurface reservoir.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

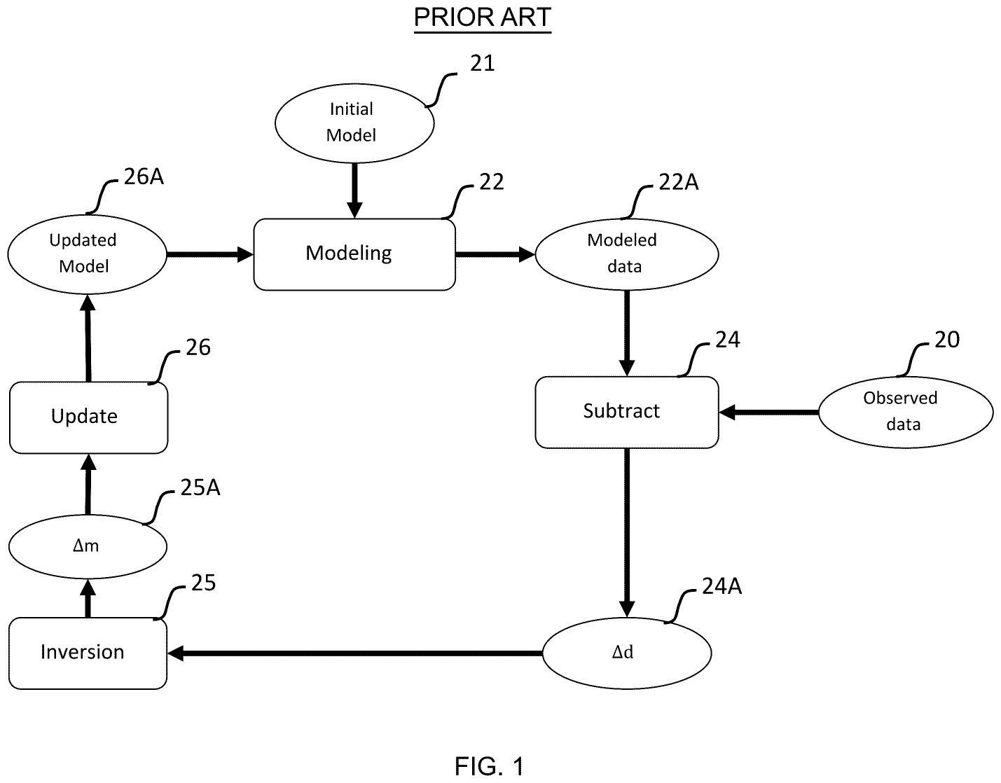

Conventional methods for estimating velocities and other earth parameters rely on ray-based algorithms based on high frequency asymptotic approximations. In recent years, full waveform inversion (FWI), based on waveform matching, has been widely used in velocity updating. FIG. 1 illustrates a method of FWI. It takes as input an initial earth model 21 and observed (i.e., recorded) seismic data 20. The earth model may include, for example, seismic velocity information such as P-wave velocity and S-wave velocity, density information, and/or other subsurface properties. The initial earth model 21 is used for forward modeling 22, such as finite-difference modeling, to generate modeled data 22A. The modeled data 22A is subtracted 24 from the observed data 20 to find the data residual 24A. The data residual 24A is then inverted 25 using, for example, a least-squares inversion. The result of the inversion 25 is a model residual 25A. The model residual 25A is then used to update 26 the earth model so that an updated model 26A is created. This process can be repeated to refine the earth model further until the data residual 24A is below some threshold.

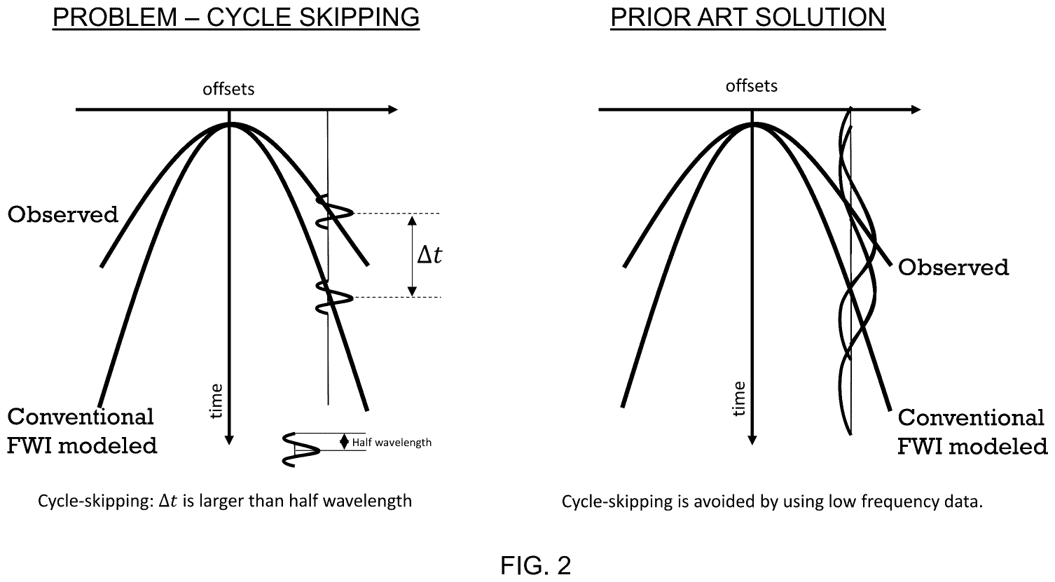

FIG. 2 illustrates a problem called cycle skipping that occurs in conventional FWI and a conventional solution. The left-hand panel shows a diagram of a common-image-point (CIP) gather in observed data and conventional full waveform inversion (FWI) modeled data. An example wavelet at a normal seismic frequency is shown on both CIP gathers. As can be seen, the difference in the arrival time (Δt) between the observed and conventional FWI modeled data is greater than half the wavelength. This means that during FWI, the FWI result will not be able to converge to an accurate model. The conventional solution for this is to use low frequencies, as seen in the right-hand panel. However, often the observed data does not include the low frequencies needed for this solution.

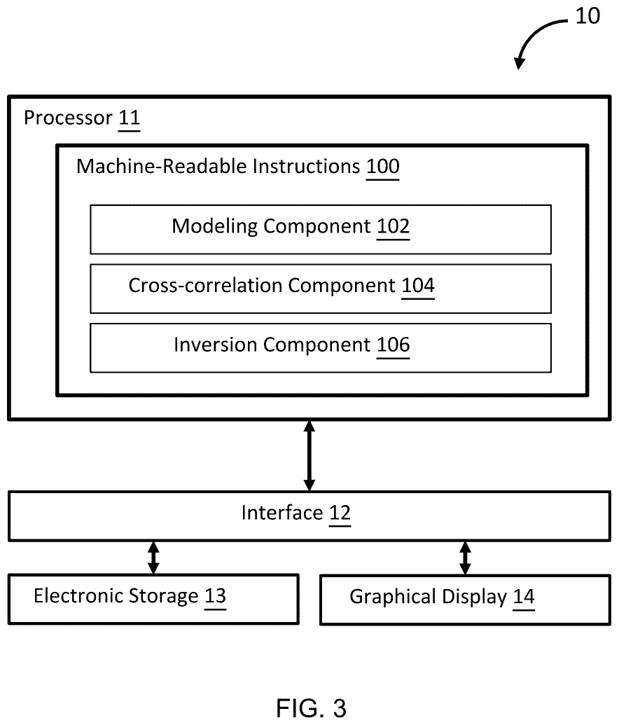

The methods and systems of the present disclosure may be implemented by a system and/or in a system, such as a system 10 shown in FIG. 3. The system 10 may include one or more of a processor 11, an interface 12 (e.g., bus, wireless interface), an electronic storage 13, a graphical display 12, and/or other components. The processor 11 is configured to receive an initial subsurface model and a seismic dataset and perform operations to generate an updated subsurface model.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to seismic data, subsurface models, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to seismic data, subsurface models, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate full waveform inversion. The machine-readable instructions 100 may include one or more computer program components. The machine-readable instructions 100 may include a modeling component 102, a cross-correlation component 104, and an inversion component 106, and/or other computer program components.

It should be appreciated that although computer program components are illustrated in FIG. 3 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the modeling component 102 may be configured to receive an earth model including properties such as seismic velocity (P-wave velocity and/or S-wave velocity), density information, and/or other subsurface properties to generate modeled seismic data. This may be done, for example, using finite-difference modeling.

The cross-correlation component 104 may be configured to cross-correlate the modeled seismic data and observed data. It may also be configured to perform decorrelation, which is the mathematical adjoint operation to cross-correlation.

The inversion component 106 may be configured to use the difference in two seismic datasets to find a difference in the earth model which can then be applied to the update the earth model.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

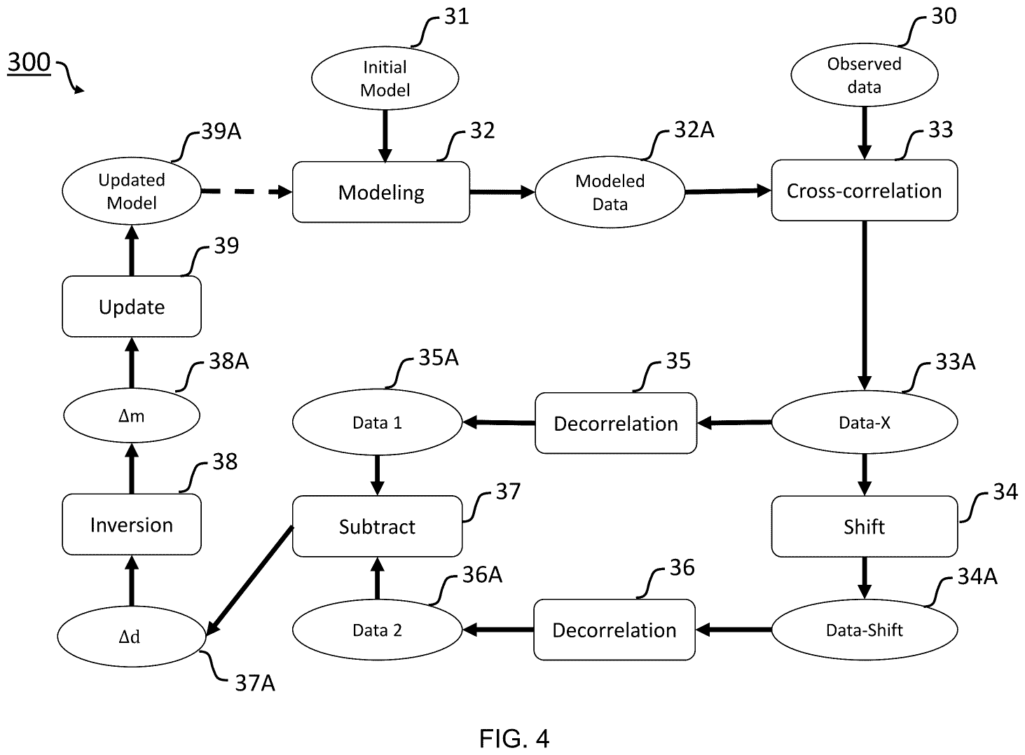

FIG. 4 illustrates an example process 300 for full waveform inversion. At step 31, an initial earth model is received. The earth model contains information on the subsurface properties such as seismic P-wave velocity and the like. Operation 32 performs seismic modeling on the earth model, such as finite-difference modeling (FDM), to generate modeled seismic data 32A.

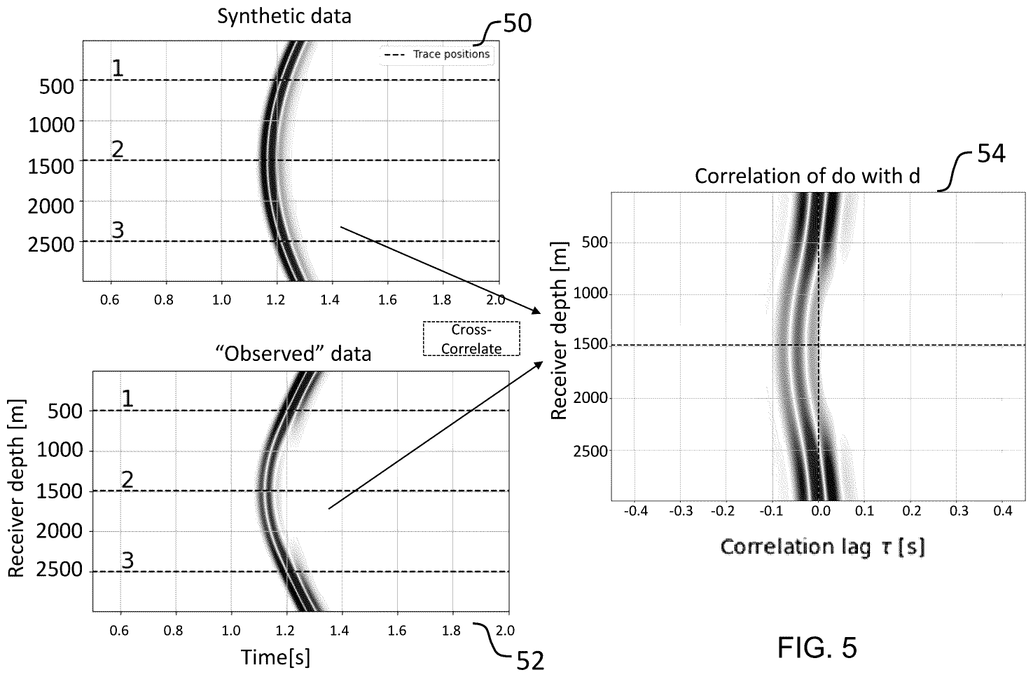

Process 300 also receives observed seismic data 30. This observed seismic data has been recorded by seismic sensors as previously described. The modeled seismic data 32A and the observed seismic data 30 are windowed and cross-correlated in time, trace-by-trace, at operation 33 to generate a cross-correlated dataset 33A (Data-X). The cross-correlated dataset of each trace includes many windows and an extra-dimension, which is time lag of cross-correlation between the same window of observed and modeled trace. A simplified example of cross-correlation is shown in FIG. 5, where the synthetic data 50 (representing the modeled data in this example) is cross-correlated with the observed data 52 to generate the cross-correlated data 54 (Data-X). Note that Data-X has an axis labeled “Correlation lag” that is the time lag of cross-correlation between the same window of observed and modeled trace. If the observed and modeled trace are exactly the same, the time lag will be zero.

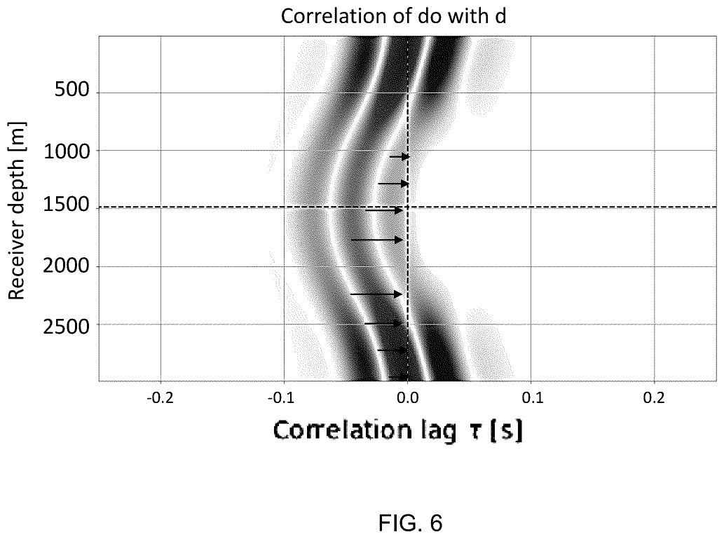

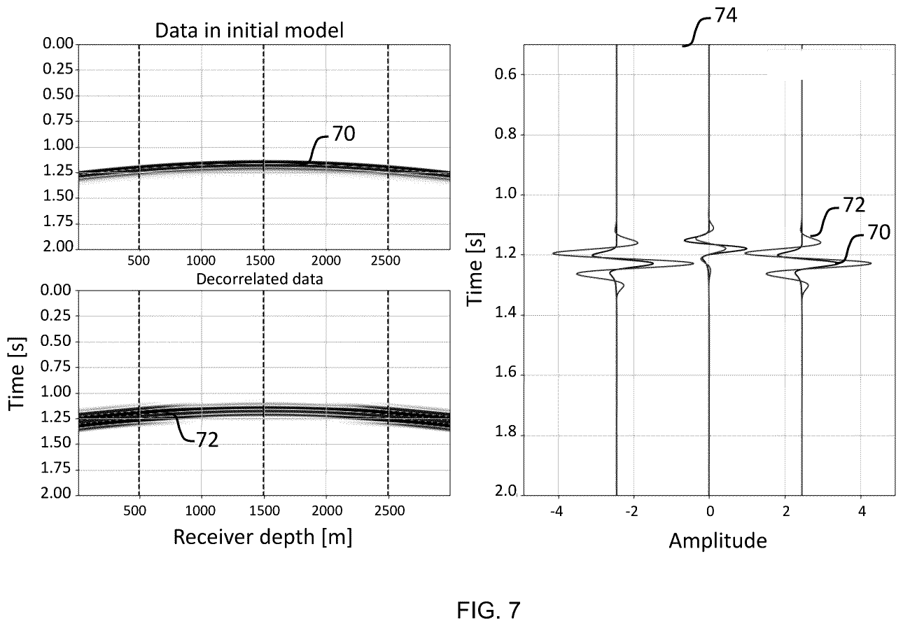

The cross-correlated dataset 33A is then time-shifted towards zero-lag at operation 34 to create a shifted cross-correlated dataset 34A (Data-Shift). This time-shift is illustrated in a simple example in FIG. 6. Here, the cross-correlated dataset (Data-X) is shown and the required time-shift is represented by the arrows. Shifting the times for each trace creates the shifted cross-correlated dataset 34A (Data-Shift). The cross-correlated dataset 33A is subjected to decorrelation, which is the mathematical adjoint of cross-correlation, at operation 35 to create Data 1 35A and the shifted cross-correlated dataset 34A is subjected to decorrelation at operation 36 to create Data 2 36A. FIG. 7 illustrates a simple example comparing modeled data 70 with the decorrelated data 72, also called the reconstructed data. Panel 74 shows three traces of modeled data 70 compared to three traces of decorrelated data 72 taken from the three locations shown as dashed lines in the panels on the left.

Referring again to FIG. 4, Data 2 36A is subtracted (operation 37) from Data 1 35A to find the data residual Δd 37A. The data residual Δd 37A has the same dimension as the original observed seismic data and is the difference between observed data and observed data without cycle-skipping. The data residual Δd 37A is inverted at operation 38 to find the model residual Δm 38A. The gradient is calculated from the data residual Δd 37A by the adjoint state method and Δm 38A is obtained by scaling the gradient using line search. The model residual Δm 38A is used to update (operation 39) the model to create an updated model 39A. This updated model 39 A may then optionally be used as the model input to operation 32 to repeat the process from operation 32 to 39, and may be repeated until the data residual Δd 37A and/or the model residual Δm 38A is minimized (i.e., essentially zero or not getting smaller between repetitions of process 300). Each optional repetition is called an iteration.

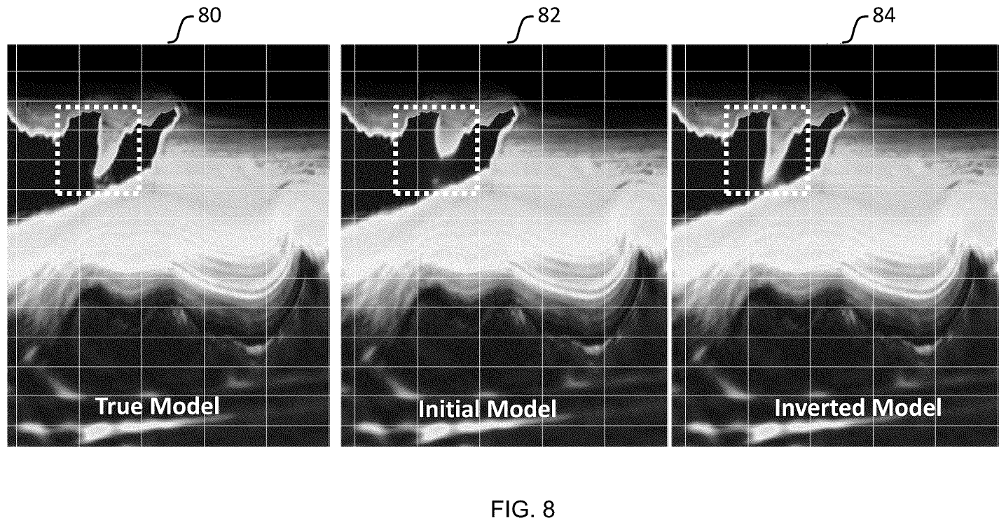

FIG. 8 shows a graphical representation of the result of the method 300. Panel 80 shows the true model, which is the “correct” answer. Panel 82 shows the initial model that was provided as input to method 300. In particular, notice that differences between the structure within the white dashed box in both panels. The deep “valley” that is in the true model does not exist in the initial model. Panel 84 shows the graphical representation of the result of method 300 (the “inverted model”). The method has successfully restored the valley inside the white dashed box.

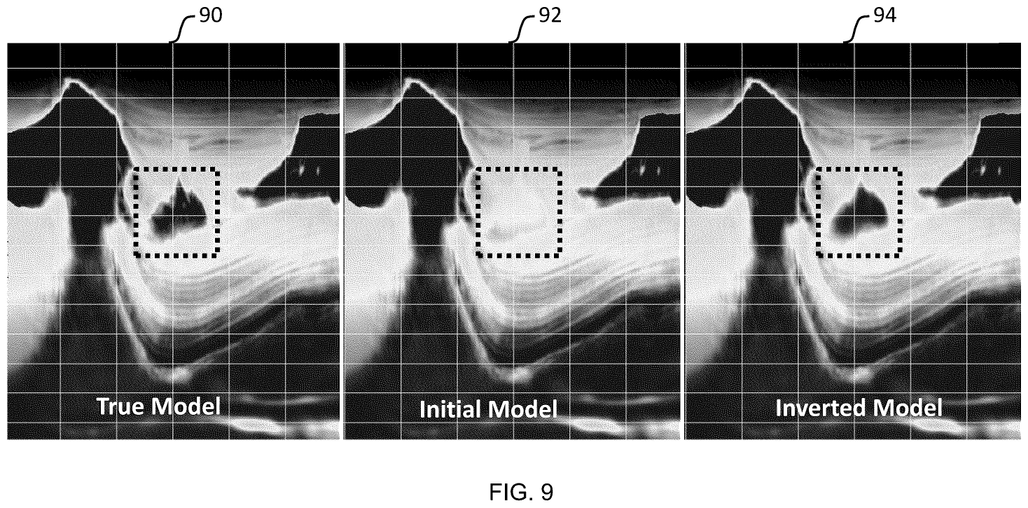

FIG. 9 shows a graphical representation of another result of the method 300. Panel 90 shows the true model, which is the “correct” answer. Panel 92 shows the initial model that was provided as input to method 300. In particular, notice that differences between the structure within the black dashed box in both panels. The separate salt body that is in the true model does not exist in the initial model. Panel 94 shows the graphical representation of the result of method 300 (the “inverted model”). The method has successfully restored the salt body inside the black dashed box.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for determining subsurface earth properties, comprising:
a. receiving an earth model and a seismic dataset representative of a subsurface volume of interest;
b. generating modeled seismic data from the earth model;
c. cross-correlating the modeled seismic data and the seismic dataset to generate a cross-correlated dataset;
d. shifting the cross-correlated dataset to generate a shifted cross-correlated dataset;
e. performing a decorrelation on the cross-correlated dataset to generate a first dataset;
f. performing a decorrelation on the shifted cross-correlated dataset to generate a second dataset;
g. calculating a data residual between the first dataset and the second dataset;
h. inverting the data residual to determine a model residual;
i. updating the earth model using the model residual to generate an updated earth model;
j. generating a graphical representation of the updated earth model; and
k. displaying the graphical representation on a graphical display.

2. The method of claim 1 further comprising repeating steps b-i with the updated earth model then proceeding to steps j and k.

3. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive an earth model and a seismic dataset representative of a subsurface volume of interest;
b. generate modeled seismic data from the earth model;
c. cross-correlate the modeled seismic data and the seismic dataset to generate a cross-correlated dataset;
d. shift the cross-correlated dataset to generate a shifted cross-correlated dataset;
e. perform a decorrelation on the cross-correlated dataset to generate a first dataset;
f. perform a decorrelation on the shifted cross-correlated dataset to generate a second dataset;
g. calculate a data residual between the first dataset and the second dataset;
h. invert the data residual to determine a model residual;
i. update the earth model using the model residual to generate an updated earth model;
j. generate a graphical representation of the updated earth model; and
k. display the graphical representation on a graphical display.

4. The system of claim 3 further comprising repeating steps b-i with the updated earth model then proceeding to steps j and k.

5. A non-transitory computer readable storage medium storing one or more programs, the one or more programs comprising instructions, which when executed by an electronic device with one or more processors and memory, cause the device to
a. receive an earth model and a seismic dataset representative of a subsurface volume of interest;
b. generate modeled seismic data from the earth model;
c. cross-correlate the modeled seismic data and the seismic dataset to generate a cross-correlated dataset;
d. shift the cross-correlated dataset to generate a shifted cross-correlated dataset;
e. perform a decorrelation on the cross-correlated dataset to generate a first dataset;
f. perform a decorrelation on the shifted cross-correlated dataset to generate a second dataset;
g. calculate a data residual between the first dataset and the second dataset;
h. invert the data residual to determine a model residual;
i. update the earth model using the model residual to generate an updated earth model;
j. generate a graphical representation of the updated earth model; and
k. display the graphical representation on a graphical display.

6. The device of claim 5 further comprising repeating steps b-i with the updated earth model then proceeding to steps j and k.
